(19) United States
(12) Patent Application Publication
(10) Pub. No.: US 2012/0189917 A1
(43) Pub. Date: Jul. 26, 2012

(54) ELECTROCHEMICAL ENERGY STORE COMPRISING A SEPARATOR

(75) Inventors: Annette Heusser-Nieweg, Ottikon (CH); Peter Terstappen, Oetwil (CH)

(73) Assignee: OXYPHEN AG, Lachen (CH)

(21) Appl. No.: 13/499,636

(22) PCT Filed: Sep. 28, 2010
(86) PCT No.: PCT/CH2010/000233

§ 371 Date: Mar. 30, 2012

(30) Foreign Application Priority Data
Oct. 2, 2009 (CH) 01522/09
Dec. 18, 2009 (CH) 1953/09

(51) Int. Cl. H01M 2/14; H01M 2/16

(52) U.S. Cl. 429/250; 429/247; 429/249

(57) ABSTRACT

An electrochemical energy store comprising a separator (40, 40a, 40b) is described, wherein said electrochemical energy store has a positively charged electrode (20), a negatively charged electrode (30), an electrolyte, and a porous separator (40, 40a, 40b) which separates the positively charged electrode (20) and the negatively charged electrode (30) from each other. The separator (40, 4a, 40b) includes at least one microporous foil which is produced using ion irradiation, among other things. The separator (40, 40a, 40b) farther includes ion ducts (43) extending at different angles from one another.

### TECHNICAL FIELD

The present invention relates to an electrochemical energy store having a positively charged electrode, a negatively charged electrode and a porous separator. The porously designed separator is used to isolate the positively charged electrode and the negatively charged electrode from one another.

### PRIOR ART

The prior art discloses various types of electrochemical energy stores which are used to supply electrically operated appliances with power. Such energy stores are usually called batteries or accumulators. When the battery or accumulator is discharged, chemical energy is converted to electrical power by an electrochemical redox reaction. Said electrical power can be used in a wide variety of ways by an electrical load connected to the electrochemical energy store.

Electrochemical energy stores can generally be classified into a first group of nonchargeable primary batteries and a second group of rechargeable secondary batteries. In this case, secondary batteries can be returned, following discharge, to a charge state which largely corresponds to the original charge state prior to discharge, which means that it is possible to repeatedly convert chemical energy to electrical power and back.

Essential quality criteria of primary and secondary batteries are high energy density, good thermal stability and the delivery of a constant voltage over the discharge period. In addition, preferred batteries have no “memory effect”, which means that they do not suffer any loss of capacity even with multiple charging/discharge operations. Furthermore, the raw materials used in the batteries should be sufficiently present in nature, as a result of which these battery types can be produced inexpensively even in the long term.

The way in which batteries work is based on an electrochemical redox reaction which is known to a person skilled in the art, wherein the battery discharge involves the occurrence of reducing processes at a positively charged electrode (cathode) and oxidizing processes at a negatively charged electrode (anode). There is thus ion transportation, which takes place within an electrolyte, wherein the process can be reversed in the case of a rechargeable secondary battery in order to recharge the battery. In order to isolate the anode and the cathode from one another physically and electrically, a separator is used in the battery. Said separator is wetted with the electrolyte and has the particular task of preventing electrical shorts within the battery, but at the same time needs to be permeable to ions in order to be able to guarantee the electrochemical reactions.

The separator is therefore an important element which concurrently influences the properties of the battery to a significant degree. The internal resistance, the charge capacity, the charging/discharge current and further electrical properties of the battery are concurrently determined by the separator to a definitive degree. The separator should be mechanically robust and have good ion permeability. The demands on batteries include not only high energy density but also, in particular, high power density in order to be able to provide a large volume of power within a short time. However, the power density is influenced particularly by the permeability of the separator. The separator should accordingly be designed such that it transmits as large a volume of ions as possible per unit time. Inter alia, the thickness of the separator should therefore be as small as possible. Furthermore, the separator should be easily wettable, have long-term robustness toward the chemicals and solutions which occur in the battery, and react insensitively to temperature fluctuations as may occur in batteries.

The prior art primarily uses separators which are based on polyolefins. However, these have the disadvantage that they react sensitively to increased temperatures and particularly to temperatures of above 150° C. Thus, the melting temperature of polyolefins is relatively low, and a separator designed in this manner has low dimensional stability in respect of heating. This can cause shorts inside the battery, which in turn result in a rise in temperature. The battery is permanently damaged as a result. Specifically in the field of batteries of high-power design or when external shorts occur, however, very severe internal heating may arise which the separator should withstand so as not to irreversibly damage the battery.

EP 0 851 523 discloses a separator which comprises a membrane based on a polyethylene terephthalate (PET) nonwoven. The thermal stability of this membrane is significantly increased in comparison with the separators which are based on polyolefins. Further such purely PET-based separators are likewise described in US 2003/0190499 and US 2006/0019164. However, a drawback of such separators is the effect of the relatively large pores, which have an average diameter of between 5 μm and 15 μm. Furthermore, the variance in the pore diameter is large, which means that short-circuit currents may be produced particularly in the region of relatively large pores. Furthermore, the nonwoven-type structure of the separator means that it does not have well-defined ion channels, but rather has a spongy quality. The path of the ions from one to the other side of the separator membrane acting as a depth filter is significantly extended thereby, and the pore size varies to an accordingly great extent both in the direction through the separator and over the surface area of the separator. A further known problem of such separators is what is known as dendritic growth. This involves the formation, starting from the electrodes, of a type of enlarging “stalactites”, which sometimes pass through the separator and can therefore form an internal short. Separators which have a spongy structure are susceptible to this dendritic growth particularly because, firstly, sometimes excessively large pores, which cause high local current density, are already present, and, secondly, the thinly produced sponge structures are easily perforated.

Further PET-based separators are specified in JP 2005/293891 and CN 2009/69179.

In order to improve the properties of a lithium ion battery and to reduce the pore size of the separator, EP 2 077 594 and US 2003/0190499 specify separators in which a respective PET-based nonwoven is coated with an organic polymer such as polyvinylidene fluoride (PVdF). US 2006/0019164 describes a PET separator with a ceramic coating. A drawback of these separators, however, is the effect of the depth filter structure, in particular, and in the case of ceramic also of the fragility and complicated production.

### PRESENTATION OF THE INVENTION

It is an object of the present invention to specify an electrochemical energy store which has a separator which eliminates the aforementioned drawbacks.

This object is achieved by an electrochemical energy store having the features of claim 1. Further embodiments are specified in the dependent claims.

The present invention thus provides an electrochemical energy store having a separator which has the following features:

a positively charged electrode,

a negatively charged electrode, and

an electrolyte.

The separator isolates the positively charged electrode and the negatively charged electrode from one another and is of porous design. Furthermore, the separator has at least one microporous membrane which has ion channels formed in it which are produced by means of exposure to radiation from ions, inter alia.

The ion channels in this arrangement are each at different angles to one another.

The electrochemical energy store may be a primary battery or a secondary battery. This may involve any battery type within these two groups, wherein particularly the positively charged electrode and the negatively charged electrode and also the electrolyte are then designed from an appropriate material. In the group of primary batteries, for example, a lithium battery would be conceivable. In the case of a secondary battery, the electrochemical energy store may relate to battery types such as a lead acid battery, a lead gel battery, a sodium sulfur battery, a nickel lithium battery, a lithium iron phosphate battery, a lithium titanate battery or a lithium air battery. With particular preference, the electrochemical energy store is a lithium ion battery, however, in which the positively charged electrode has a lithium-containing metal oxide and the negatively charged electrode is suitable for receiving and emitting lithium ions.

Producing the microporous membrane by means of exposure to ion radiation is advantageous particularly because it allows the formation of well-defined ion channels. Exposure to ion radiation therefore prompts the formation of the ion channels. The microporous membrane may thus be produced not only by the exposure to radiation from ions but also by further method steps which can be seen in the finished membrane under a microscope, such as particularly by subsequent chemical etching. Such etching allows the removal of molecule chains which have been split up during the exposure to ion radiation, in order to form pores completely. Further and alternative further treatment steps are possible. This exposure to radiation from ions in combination with possible further method steps such as the etching described thus prompts formation of ion channels which can be seen under a microscope. In contrast to separators from the prior art which have the spongy structure of a depth filter, such a separator according to the invention allows the passage of ions on a direct, zero-resistance path. Such a separator may thus simultaneously have relatively low porosity and nevertheless very good ion permeability. It is therefore also mechanically relatively robust. The good ion permeability of the separator improves the electrical properties of the battery to a substantial degree, and the mechanical robustness of the separator facilitates production of the battery, in particular.

The separator may have a single microporous membrane, in particular. Furthermore, it may be formed solely therefrom.

Preferably, the microporous membrane is produced at least partly from polyethylene terephthalate (PET) and in particular exclusively from polyethylene terephthalate (PET). As a result, the separator is stable over a very wide temperature range. The melting point of such a PET separator is 220° C., and the separator can be operated in a range from −40° C. to 180° C. without altering its structure. By way of example, this allows the battery to be operated at high power too. In addition, PET is easily wetted with an electrolyte and has good properties in respect of processing.

Preferably, the pores of the microporous membrane are each in the form of essentially cylindrical ion channels. By “essentially”, it is meant that the diameter of the ion channels may alter slightly along the longitudinal extent thereof. The cylindrical shape of the ion channels may be hose-like or, in particular, tubular in this case. Various ion channels may also intersect. In the case of a significant majority of the pores, however, it is possible to see a clearly defined, hose-like ion channel which has at least one considerable longitudinal section which is unbranched and is not intersected by another ion channel. Such a pore structure is optimum, since the cross-sectional area of the pores can be determined very precisely, and the path for the ions through the separator is direct and without resistance.

In particular, the ion channels are each at different angles to one another. This means that the ion channels extend in different spatial directions randomly in each case. Preferably, the ion channels are each at different angles to one another not only along one dimension but also along two dimensions which each extend parallel to the membrane surface. The different ion channels are thus advantageously each askew with respect to one another in space. The mean pore diameter of the separator therefore has much lower variance particularly in the case of a high pore density. The probability of occurrence of parallel ion channels which have partially overlapping cross-sectional areas and therefore together form an excessively wide pore is substantially reduced.

Of particular advantage is an embodiment in which the angle between the surface of the separator membrane and the ion channels is at least 45° in each case. This limits the length of the ion channels. Preferably, however, at least 50% of the ion channels are at an angle of less than 70° to the surface of the separator membrane. This ensures that the angles of the ion channels to the membrane surface each differ to a sufficiently high degree from ion channel to ion channel.

The ion channels may each have an opening which widens toward the outside, as can be seen under a microscope, on both sides of the separator. Preferably, the openings in this case each widen conically toward the outside, as a result of which a single ion channel can be called double conical, and as a whole it has a kind of “hourglass shape”. This facilitates the entry of the ions into the ion channel, which benefits both the properties of the charging operation and those of the discharge operation.

In order to achieve good ion permeability for low internal resistance, on the one hand, and to ensure the mechanical robustness of the separator, on the other hand, the separator preferably has a thickness of between 12 μm and 36 μm. In this case, particularly a thickness of the separator of between 20 μm and 28 μm, preferably of approximately 23 μm, is advantageous.

In order to improve the wettability of the separator with the electrolyte, and hence to facilitate the passage of ions through the separator, the separator may have a modification to the surface which improves the wettability with liquids. This may be a chemical or a physical modification. In particular, it may also be a coating of the surface with another material, which has improved properties in terms of wettability.

In one preferred embodiment, the porosity of the separator is less than 30%. This improves the mechanical and chemical robustness. Even more advantageous in this case is an embodiment in which the porosity of the separator is less than 20%, in particular even less than 15%.

The present invention furthermore specifies a separator for use in an electrochemical energy store, wherein the separator is designed as described above, in particular is of porous design. In addition, the invention claims the use of a microporous membrane as a separator for an electrochemical energy store.

### BRIEF DESCRIPTION OF THE DRAWINGS

Preferred embodiments of the invention are described below with reference to the drawings, which are used merely for explanation and should not be interpreted as restrictive. In the drawings:

FIG. 1 shows a perspective view of an inventive battery according to a first embodiment, cut open for illustrative purposes;

FIG. 2 shows a schematic illustration of the polymer structure of a separator as can be found in the battery in FIG. 1 prior to exposure to ion radiation;

FIG. 3 shows a schematic illustration of the polymer structure of a separator as can be found in the battery in FIG. 1 following exposure to ion radiation;

FIG. 4 shows a schematic illustration of the polymer structure of a separator as can be found in the battery in FIG. 1 following exposure to ion radiation and during the etching operation;

FIG. 5 shows a microscopic view of the surface of a separator as can be found in the battery in FIG. 1;

FIG. 6 shows a microscopic sectional view at right angles to the surface of a separator as can be found in the battery in FIG. 1;

FIG. 7 shows a microscopic view of the surface of a separator based on the prior art;

FIG. 8 shows a microscopic sectional view at right angles to the surface of a separator based on the prior art;

FIG. 9 shows an apparatus for producing a separator as can be found in the battery in FIG. 1; and

FIG. 10 shows an illustration of the ion bombardment of a membrane in the apparatus in FIG. 9.

### DESCRIPTION OF PREFERRED EMBODIMENTS

FIG. 1 shows a perspective illustration of a preferred exemplary embodiment of an electrochemical energy store according to the invention. This electrochemical energy store, which is described below, is a secondary battery in the form of a lithium ion battery. However, this embodiment is only one possible example of an electrochemical energy store according to the invention. Self-evidently, the separator according to the invention can also be used in other electrochemical energy stores.

In this embodiment, the battery has an essentially cylindrical housing 10 having a circumferential side wall which contains, as the most important parts of the battery, a positively charged electrode 20 and a negatively charged electrode 30 isolated by porous separators 40a and 40b. In addition, the housing 10 contains an electrolyte which is in chemical contact with the two electrodes 20, 30 and which surrounds the two separators 40a, 40b, wetting them in the process. In this case, the negative electrode 30 has a material which is active in the chemical reaction of the charging or discharge operation and which contains graphite. In the present exemplary embodiment, the positive electrode 20 contains particularly lithium metal oxides. The positively and negatively charged electrodes 20 and 30 are each in the form of a long, ribbon-like microporous sheet 21 or 31 in this case. Similarly, the separators 40a and 40b in the present exemplary embodiment are each as a whole in the form of a membrane. The battery has two separators 40a and 40b of the same type in this case. In order to produce the battery, these cited microporous membranes are each placed congruently above one another in the order positive electrode 20—separator 40a—negative electrode 30—separator 40b and are then rolled up around a connecting pin 50 (possibly a plurality of times), wherein the positive electrode 20 comes to rest radially innermost. Even in the wound up state, the sheet 21 of the positive electrode 20 and the sheet 31 of the negative electrode 30 are thus isolated from one another at every location by respect of one of the two separators 40a and 40b. The design of the separators 40a and 40b is described in detail further below.

The connecting pin 50 is arranged centrally along the longitudinal axis of the housing 10 and is connected along a predominant portion of its length to an electrode connection 22 of the positively charged electrode 20. This electrode connection 22 is formed along that edge of the sheet 21 of the positive electrode 20 which is inside in the rolled up state and which runs parallel to the connecting pin 50. In this case, it is arranged on that side of the sheet 21 which points radially inward. The electrode connection 22 is formed particularly such that it can be connected to the connecting pin 50 and thereby makes an electrically conductive connection between the sheet 21 of the positive electrode 20 and the connecting pin 50.

The connecting pin 50 in turn is connected by means of an electrically conductive connection to a positive pole 70, which in this embodiment is formed by a top area which closes off one side of the cylindrical housing 10 to form a seal. To produce the seal, a seal 110—for example in the form of a sealing ring—is arranged between the housing 10 and the outer edge of this top area. The outwardly pointing side of the top area which forms the positive pole 70 is suitable particularly for applying a first contact of an electrical load (not shown), which may take a variety of forms.

That side of the roll formed by the electrodes 20, 30 and the separators 40a, 40b which points towards the pole 70 has an insulator 61 fitted. The insulator 61 prevents the negatively charged electrode 30 from being in electrical contact with the connecting pin 50, the pole 70 or another electrically conductive element arranged between the pole 70 and the negative electrode 30. In this case, the insulator 61, which is made from an electrically insulating material, surrounds the connecting pin 50 and extends circumferentially therefrom radially outward up to the side wall of the housing 10. In the present exemplary embodiment, this ensures that the pole 70 is electrically connected to the winding exclusively by means of the connecting pin 50, and no short inside the battery can arise between the pole 70 and the negative electrode 30.

In order to upwardly limit the temperature inside the battery, for example in the case of an external short, a PCT thermistor 100 may be provided within the electrical connection between the connecting pin 50 and the pole 70. The thermistor 100 is a temperature-dependent electrical resistor which substantially increases its resistance value in the event of an increase in the current and thereby upwardly limits the flow of current and hence also the temperature. This protects the battery against increased temperature on account of an excessive flow of current, which prevents related, irreversible damage to the battery.

In addition, a safety valve 90 may be formed in the region between the electrodes 20, 30 and separators 40a, 40b rolled up inside one another and the pole 70. This safety valve 90 allows an overpressure produced during battery charging, for example, to escape from the inside of the battery to the outside.

In the present exemplary embodiment, the sheet 31 of the negative electrode 30 has an electrode connection which is fitted along that edge of the sheet 31 which is outside in the wound up state and which runs parallel to the connecting pin 50. This electrode connection 32 is formed on that side of the sheet 31 which points radially outward, and that end of said electrode connection which is remote from the pole 70 has a tab which extends from the radial outer side of the sheet 31, beyond the edge thereof, radially inward. The tab on the electrode connection 32 is connected to a negative pole 80 which is formed by a closure area which closes the housing 10 on that side which is opposite the positive pole 70. The outer side of this closure area is suitable for applying a second contact of an electrical load—which is not shown here.

Fitted between this closure area which forms the negative pole 80 and the sheets 21, 31, 40a, 40b which are rolled up inside one another is a second insulator 62, which electrically isolates the negative pole 80 from the positive electrode 20. In the region of the tab of the electrode connection 32, the second insulator 62 is arranged between this tab and the rolled up sheets 21, 31, 40a, 40b in this case. In contrast to the first insulator 61, the connecting pin 50 does not project through the second insulator 62.

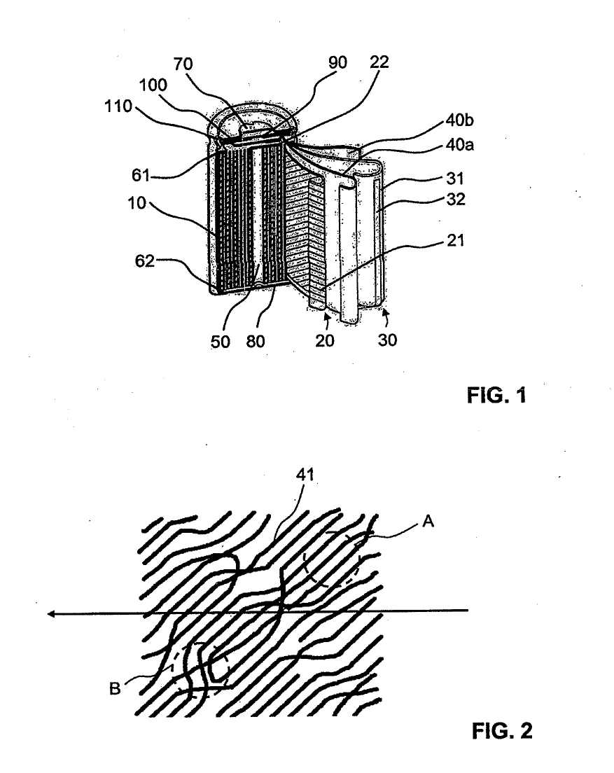

The text below describes the production of the separators 40a and 40b. A separator 40, which is suitable for use as a separator 40a or 40b in a battery, is of porous design and, when used in the battery, isolates the positively charged electrode 20 and the negatively charged electrode 30 from one another. In this case, in the present exemplary embodiment, it is particularly permeable to lithium ions. The starting material for the separator 40 comprises a uniform, homogeneous polyester and may comprise polycarbonate, polyamide or polyimide or in particular, as in the present case, polyethylene terephthalate (PET). As illustrated in FIG. 2, this starting material is constructed at a molecular level by a multiplicity of polymer chains 41, these being able to form a crystalline (corresponding to region A in FIG. 2) through to amorphous (region B in FIG. 2) structure in different regions as the case may be.

To produce the pores, the starting material of the separator 40, having been processed to form a membrane, is exposed to radiation by means of ions during a particular time. In this case, this exposure to radiation is effected essentially from a direction which is at right angles to the membrane surface, as indicated in FIG. 2 by an arrow which indicates the direction of exposure to radiation. In this case, the rear and front membrane surfaces are on the left-hand and the right-hand side, respectively, in FIG. 2. Depending on the intensity and duration of this exposure to radiation, a different pore density can be determined in this case. Although there are local variations in the pore density, they are relatively small. The exposure to radiation destroys or breaks the polymer chains 41 in the respective regions in which the ions pass through the membrane, as shown in FIG. 3. In this case, a passage of ions involves the formation of a respective path of destroyed polymer chains 41 which extends through the membrane. This path, which is marked by two horizontal solid lines in FIG. 3, has a diameter d (see FIG. 3) of between approximately 5 nm and 7 nm.

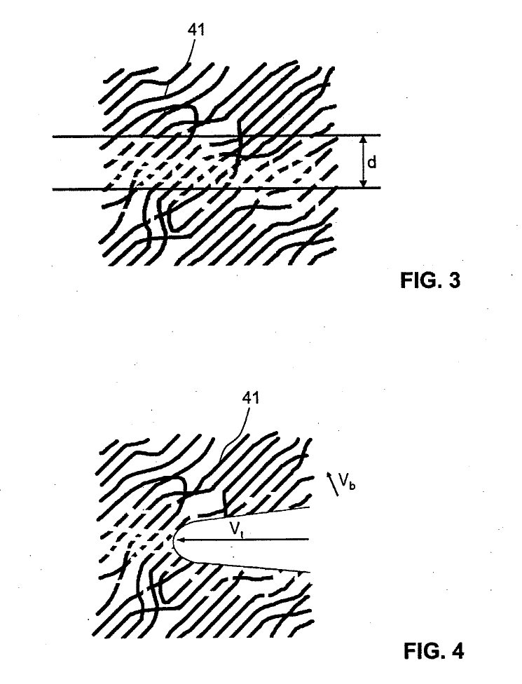

The membrane according to this embodiment is then dipped in a bath which contains etching materials and is drawn through it. The etching materials used for this purpose are highly alkaline solutions, such as potassium hydroxide solution and sodium hydroxide solution. The etching operation removes particularly the polymer chains broken by the exposure to ion radiation, which produces a pore running through the membrane. As FIG. 4 shows, the etching liquid spreads out during the etching operation not only at right angles to the membrane surface along the path formed by the exposure to ion radiation, but also in all directions at right angles thereto. In this case, when it spreads out, the etching liquid forms an etching front in the separator membrane. The speed Vₜ at which this etching front spreads out in the direction of the path formed by the ion bombardment is substantially, that is to say a multiple, higher than the speed V_{b} at which the etching front spreads out at right angles to this path, however. The reason for this is that the destroyed polymer chains make it significantly easier for the etching front to spread out in the relevant direction of the path formed by the exposure to ion radiation. After a certain time, the etching front has passed through the membrane and the pores are formed. In order to obtain a wider and precisely predetermined pore diameter, however, the membrane can remain in the bath with the etching liquid for even longer, which causes the pores to widen in accordance with the already cited speed V_{b}.

The production process can be completed by further steps such as neutralization, rinsing and drying. To this end, the separator membrane is drawn through appropriate baths in succession. The process can also be extended and, by way of example, comprise a step to modify the surface, which involves the microporous membrane, in which pores are already formed, being altered such that its wettability with liquids is improved. This modification can be made by chemical or by physical means. Further production steps are possible.

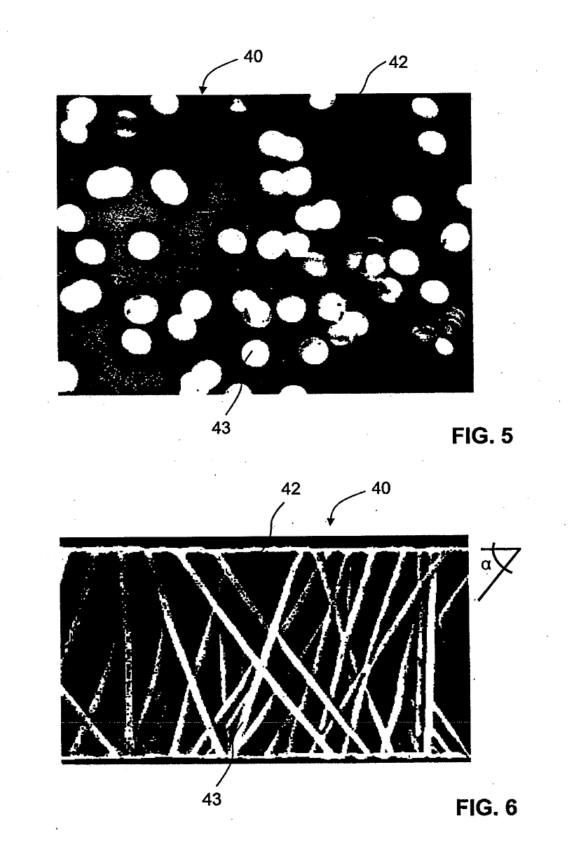

As shown in a microscopic illustration in FIGS. 5 and 6, the pores 43 of the separator 40 are of essentially cylindrical form and connect the top of the separator membrane to the bottom on an essentially straight path. The pores 43 have a solid 42 formed between them which is impenetratable to ions. The pores 43 have a well-defined structure, and an ion passes through the separator 40 through one of the pores 43 on a rectilinear, direct path which is free of resistances. The pores 43 are thus actual ion channels which are clearly visible in the separator under a microscope.

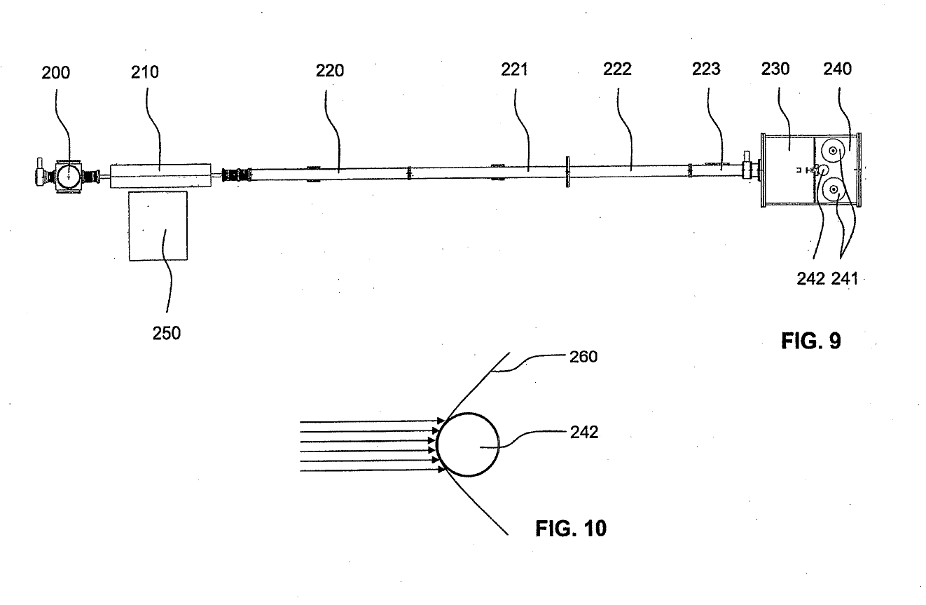

As can clearly be seen in FIG. 6, the ion channels or pores 43 are each oblique to one another, that is to say at different angles to one another, in particular. Such an obliquely running form of the ion channels is achieved by virtue of the ions consciously being deflected into corresponding, different spatial directions relative to the surface of the membrane, when the separator membrane is exposed to radiation. A possible method for producing such obliquely running ion channels is described further below with reference to FIGS. 9 and 10. Advantageously, the angle α (see FIG. 6) of an ion channel relative to the membrane surface is in each case at least 45° in all directions, however. Preferably, more than 50% of all the ion channels are at an angle of less than 70° to the membrane surface. In this case, the angle of the ion channels 43 relative to the membrane surface is respectively determined during the exposure to ion radiation by the direction of the ion passage through the membrane. The fact that the ion channels 43 each run askew relative to one another ensures that, particularly in the case of a separator 40 with a high pore density, the cross-sectional areas of two or more pores do not coincide and that a pore with an enlarged cross-sectional area is not formed as a result. This would be possible if the ion channels were to run parallel to one another. Although it is possible for the ion channels 43 running obliquely relative to one another to intersect at the surface, for example, as can be seen multiple times in FIG. 5, or at another level of the membrane, that is to say to have an at least partially overlapping-cross-sectional area at one location, the oblique, random arrangement means that the ion channels 43 then run independently of one another and in different directions outside of this common point of intersection. The definitive cross-sectional area for ion passage thus continues to be determined by the diameter of the individual ion channel rather than by the common cross-sectional area at a point of intersection with another ion channel. The respective differently oblique course of the ion channels 43 thus allows the cross-sectional area of the pores to be defined precisely, and allows the variance in this cross-sectional area of pores over the entire separator 40 to be kept substantially lower.

The ion channels 43 may be in a form such that they are in funnel-shaped form in the region of their openings with which they open outward at the two membrane surfaces, in which case they widen conically toward the outside. In this case, the ion channels may have such funnel-shaped openings on both sides of the membrane, that is to say may be double conical and have a type of “hourglass shape”. This facilitates the entry of an ion into an ion channel 43. Such a double conical shape of an ion channel 43 is produced during the etching operation, since the etching chemical requires a certain period in order to penetrate the ion channels and produce them. As a result, the etching chemical acts for longer at the surface of the membrane or in the entry region of the ion channels than inside the ion channels. This prompts the formation of ion channel openings which widen conically toward the outside, which is clearly visible under a microscope particularly in the case of relatively thicker separator membranes.

The pores 43 advantageously, have a diameter of between 0.01 μm and 10 μm, the separator 40 preferably having a pore density of between 10E5 and 10E9 pores per cm².

In one specific, preferred exemplary embodiment, the separator 40 is produced from polyethylene terephthalate (PET), wherein its surface is modified such that it has properties which improve wettability with liquids. The thickness of the separator 40 is 23±2 μm, and the pore diameter is 0.2±0.02 μm. The density of the pores is 320±40*10E6 pores per cm². As a characteristic value for its ion permeability, such a separator allows, per cm², an air throughput of more than 2.5 liters per minute and per bar. The bursting pressure of the separator is then more than 0.95 bar, and the separator has a temperature stability of up to above 220° C.

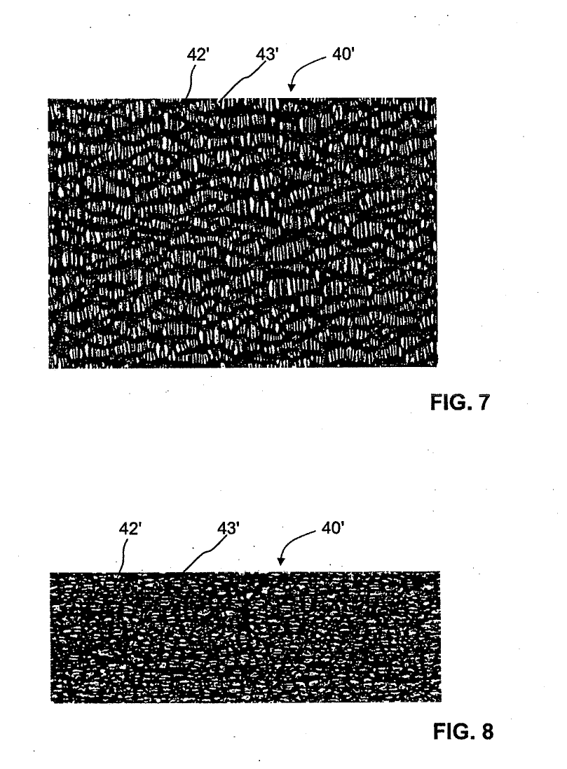

The separator 40 produced in this manner has a porosity of approximately 12%. In comparison with separators from the prior art, which are based on polyolefins or coated PET nonwovens, for example, this value is very low. Nevertheless, the ion permeability in the case of the present separator is significantly improved in comparison with the separators from the prior art, particularly in respect of the ions transmitted per unit time. This can be explained with the special, rectilinear and tubular pore structure of the described separator 40, as shown in FIGS. 5 and 6, in comparison with the pore structure of conventional separators. Such a pore structure of a separator 40′ from the prior art is shown in plan view in FIG. 7 and in cross section in FIG. 8. To produce the pores, the separator material, which is based on polyolefins in this case, is pulled apart in a stretching process, as a result of which a fibrillar spongy structure is formed.

The solid 42′ thereby forms a multiplicity of islands which are connected to one another by means of a multiplicity of branches, as can be seen in FIG. 7. In the interspaces, the pores 43′ are formed. However, these pores 43′ do not have a cylindrical, rectilinear structure but rather are formed by highly contorted and random paths through the dendritic structure of the separator solid 42′. A passage path for an ion from one side to the other of the separator 40′ is extended significantly as a result, and the pore diameter is not clearly determined and has a correspondingly large variance. Furthermore, the relatively poor wettability of the polyolefin-based material in comparison with PET has an adverse effect on the properties of the separator in this case.

FIG. 9 schematically shows a possible apparatus for producing ion channels inclined obliquely with respect to one another in a membrane. The apparatus has an ion source 200 which emits ions. The ions are accelerated within a magnetic field, which is formed in the acceleration sections 220, 221, 222 and 223, along a longitudinal axis in the direction of a target, which in this case is a membrane 260, particularly a PET membrane. The magnetic field strengths of the acceleration sections 220 to 223 may each be different in this case and, in particular, may rise continuously from the acceleration section 220 to the acceleration section 223. After passing through the acceleration sections 220 to 223, however, the energy of the ions must at any rate be sufficiently high to penetrate the target or the membrane 260. On account of the length of the acceleration sections 220 to 223, there is the assurance that the ions hit the target within a particular angle range. Such ion accelerators have been known for a long time in the prior art.

Arranged between the ion source 200 and the acceleration sections 220 to 223 is what is known as a wobbler 210, which is used to fan out the ion beam. The wobbler 210 surrounds the ion beam and in so doing exposes it to an electromagnetic field which is variable over time. In this case, a power supply 250 supplies an AC voltage to the wobbler. Since the wobbler 210 fans out the ion beam, the ions do not hit the target at a pinpoint location, but rather are scattered over a certain width or area.

The membrane 260 to be exposed to radiation is rolled up on one of the winding rollers 241 in the winding chamber 240 and, during the exposure to ion radiation, is continuously rewound from one winding roller 241 to the other winding roller 241 using a proven method. In the process, the membrane 260 runs over a deflection roller 242 arranged between the two winding rollers 241. The deflection roller 242 is arranged precisely on the longitudinal axis of the ion beam. As a result, the membrane 260 has a radius corresponding to the radius of the deflection roller 242 in that region in which said membrane is bombarded by the ion beam, as shown in FIG. 10 (arrows represent the fanned out ion beam). The effect of this, in particular, is that the ions penetrate the membrane 260 at different angles and thereby produce ion channels with different inclinations. In this case, the membrane is therefore deliberately arranged relative to the direction of exposure to the ion radiation such that it is penetrated by the ions in different spatial directions. Alternatively or in addition, it is naturally also possible for the ions to be deflected relative to the membrane surface. This can be done using a wobbler, in particular. In the present exemplary embodiment, the wobbler 210 is also actually used to amplify the effect shown in FIG. 10 by virtue of the wobbler 210 fanning out the ion beam such that the individual ions move through the acceleration sections 220-223 at least slightly different angles relative to the longitudinal axis of the ion beam.

During the ion bombardment, the membrane 260 is advantageously guided more than once, in particular at least twice, via the deflection roller 242 or rewound from one of the winding rollers 241 to the other winding roller 241. As a result, the membrane 260 is exposed to the ion bombardment more than once. Advantageously, the membrane 260 is in this case exposed to the ion beam such that the ion channels produced do not just run obliquely with respect to one another along one dimension but rather each have different inclinations relative to one another along two dimensions. The probability of parallel ion channels with partially overlapping cross-sectional areas occurring can be reduced further as a result. In order to achieve this, the membrane 260 can be guided via the deflection roller 242 in a different orientation for fresh ion bombardment, for example. However, it is also possible for the ions to be deliberately deflected in spatial directions which are perpendicular to one another and hence to be fanned out in two dimensions, for example. Various options are conceivable in this regard.

The invention is self-evidently not limited to the above exemplary embodiment, and a large number of modifications are possible. In particular, the battery does not have to be a lithium ion battery. It also does not necessarily have to be a secondary battery. The electrochemical energy store could equally well be in the form of a primary battery. In such a case, the positive or negative electrode would accordingly be produced from a different material that is known to a person skilled in the art from the prior art. Similarly, the electrolyte would then have a different chemical composition, and then accordingly not lithium ions but rather other ions would be involved in the ion transportation through the separator. In such a case, the separator would naturally be matched to the specific battery type and particularly to the properties of the ions to be transmitted. Furthermore, the battery may have a different physical shape than the cylindrical one described, for example, and may be in the form of a button cell, flat battery or in the form of a block, for example. In addition, the battery may have a separator which has further surface coatings to improve its physical and/or chemical properties. A large number of further modifications are possible.

### LIST OF REFERENCE SYMBOLS

| | |
|---|---|
| 10 | Housing |
| 20 | Positively charged |
| | electrode |
| 21 | Electrode sheet |
| 22 | Electrode connection |
| 30 | Negatively charged |
| | electrode |
| 31 | Electrode sheet |
| 32 | Electrode connection |
| 40, 40′, 40a, 40b | Separator |
| 41 | Polymer chain |
| 42, 42′ | Solid |
| 43, 43′ | Pore |
| 50 | Connecting Pin |
| 61 | First insulator |
| 62 | Second insulator |
| 70 | Positive pole |
| 80 | Negative pole |
| 90 | Safety valve |
| 100 | Thermistor |
| 110 | Seal |
| 200 | Ion source |
| 210 | Wobbler |
| 220, 221, 222, 223 | Acceleration section |
| 230 | Radiation chamber |
| 240 | Winding chamber |
| 241 | Winding rollers |
| 242 | Deflection roller |
| 250 | Power supply |
| 260 | Membrane |

1. An electrochemical energy store having a separator, wherein the electrochemical energy store has
a positively charged electrode
a negatively charged electrode and
an electrolyte,
wherein the separator isolates the positively charged electrode and the negatively charged electrode from one another and is of porous design,
wherein the separator has at least one microporous membrane which has ion channels formed in it which are produced by means of exposure to radiation from ions, inter alia,
and wherein the ion channels are each at different angles to one another.

2. The electrochemical energy store as claimed in claim 1, wherein the microporous membrane is furthermore produced by means of etching.

3. The electrochemical energy store as claimed in claim 1, wherein the microporous membrane is produced at least partly from polyethylene terephthalate (PET) and in particular exclusively from polyethylene terephthalate (PET).

4. The electrochemical energy store as claimed in claim 1, wherein the pores of the microporous membrane are each in the form of essentially cylindrical ion channels.

5. The electrochemical energy store as claimed in claim 1, wherein the ion channels each have an opening which widens toward the outside on both sides of the separator.

6. The electrochemical energy store as claimed in claim 1, wherein the separator has a thickness of between 12 μm and 36 μm.

7. The electrochemical energy store as claimed in claim 1, wherein the separator has a thickness of between 20 μm and 28 μm.

8. The electrochemical energy store as claimed in claim 1, wherein the separator has a modification to the surface which improves the wettability with liquids.

9. The electrochemical energy store as claimed in claim 1, wherein the porosity of the separator is less than 30%.

10. The electrochemical energy store as claimed in claim 9, wherein the porosity of the separator is less than 20%.

11. The electrochemical energy store as claimed in claim 10, wherein the porosity of the separator is less than 15%.

12. The electrochemical energy store as claimed in claim 1, wherein the positively charged electrode has a lithium-containing metal oxide and the negatively charged electrode is suitable for receiving and emitting lithium ions.

13. A separator for use in an electrochemical energy store with a positively charged electrode, a negatively charged electrode, and an electrolyte, wherein the separator is of porous design and is suited to isolate the positively charged electrode and the negatively charged electrode from one another,
wherein the separator has at least one microporous membrane which has ion channels formed in it which are produced by means of exposure to radiation from ions, inter alia,
and wherein the ion channels are each at different angles to one another.

14. The use of a microporous membrane as a separator for an electrochemical energy store with a positively charged electrode, a negatively charged electrode, and an electrolyte wherein the membrane is of porous design and is suited to isolate the positively charged electrode and the negatively charged electrode from one another,
wherein the membrane has ion channels formed in it which are produced by means of exposure to radiation from ions, inter alia,
and wherein the ion channels are each at different angles to one another.
